(19) United States
(12) Patent Application Publication
(10) Pub. No.: US 2009/0063223 A1
(43) Pub. Date: Mar. 5, 2009

(54) Systems and methods for assessing the level of conformance of a business process

(76) Inventors: Mitchel Dru Elwell, Chillicothe, IL (US); Jeffery Murray Pohl, Mapleton, IL (US); Julie Lynn Hammond, Peoria, IL (US); Leslie Jane Paulson, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/896,383

(22) Filed: Aug. 31, 2007

(51) Int. Cl. G06Q 10/00

(52) U.S. Cl. 705/7

(57) ABSTRACT

A system for assessing a level of conformance of a business process with one more activities is disclosed. The disclosed system includes a memory to store program code and a process to assess the level of conformance. The assessment process includes storing a process standard, a business process classification, and a conformance scoring criterion, and determining a first conformance score for a first activity in the business process based on the conformance scoring criterion and the process standard. The assessment process further includes the steps of determining a second conformance score for a group of activities including the first activity based on one or more conformance scores including the first conformance score, determining a third conformance score based on the second conformance score, and assessing the level of conformance of the business process based on the third conformance score.

### TECHNICAL FIELD

The present disclosure relates generally to a system for managing business processes, and more particularly to assessing the conformance level of a business process based on one or more process conformance scores.

### BACKGROUND

A business organization that implements complex business processes may desire to monitor and assess the quality of the implementations. For example, a New Product Introduction (“NPI”) process refers to the complex business process for introducing new products to market. The NPI process may be a cross-functional business process involving the idea conception, design, engineering, manufacturing, and marketing functions of a business organization. The implementation of the NPI process often focuses on improving speed to market for a new product. At the same time, the business organization may desire to ensure that the new product or service introduced by the NPI implementation is of high-quality.

To achieve the goal of delivering high-quality products and services, the business organization may require that the business process for delivering its product or service be implemented according to a set of best practices defined by the organization. The business organization may thus implement a system and/or a process to assess the quality of a complex business process. However, without proper goals and metrics, an assessment process may be unnecessarily disruptive and inefficient for the business organization.

To resolve the tension between achieving accelerated speed to market and ensuring the high quality of the products, it is necessary to efficiently assess the quality of a complex business process, such as the NPI process. Systems and methods have been developed to manage various business processes. For example, U.S. Pat. No. 5,208,765 to Turnbull discloses a method and structure for monitoring product development. In Turnbull, the product development is divided into a plurality of stages. Each stage in turn includes a set of requirements that must be completed in order for the stage to be completed. Each requirement is provided with a unique identifier for ease of reference to the requirement. Each requirement is also associated with an indicator for indicating the status of that requirement (i.e., whether the requirement is complete or not). Each stage and its requirements are capable of being visually displayed, typically on a display unit connected to a computer system. Thus, a user is capable of easily determining the instantaneous status of the development of the product by reviewing each of the requirements of each of the stages of the product development and determining from the display the status of each requirement.

While conventional systems, such as the embodiments disclosed in Turnbull, may provide tools and mechanisms for monitoring a product development process, the prior art systems may not reflect detailed business management goals and requirements of the business organization through each stage of a business process. As such, there is a need to provide a process for assessing the quality of a business process in real time, having a set of defined metrics at each stage of the business process. Further, there is a need for systems and methods that enable real time risk management functions throughout the various stages of a business process.

### SUMMARY OF THE INVENTION

A system for assessing a level of conformance of a business process with one more activities is disclosed. The disclosed system includes a memory to store program code and a process to assess the level of conformance. The assessment process includes storing a process standard, a business process classification, and a conformance scoring criterion, and determining a first conformance score for a first activity in the business process based on the conformance scoring criterion and the process standard. The assessment process further includes the steps of determining a second conformance score for a group of activities including the first activity based on one or more conformance scores including the first conformance score, determining a third conformance score based on the second conformance score, and assessing the level of conformance of the business process based on the third conformance score.

### BRIEF DESCRIPTION OF THE DRAWINGS

The accompanying drawings, which are incorporated in and constitute a part of this specification, illustrate exemplary embodiments of the disclosure and together with the description, serve to explain the principles of the disclosure. In the drawings:

FIG. 1A is a block diagram of an exemplary business process consistent with certain embodiments of the present disclosure;

FIG. 1B is a block diagram of an exemplary business process conformance level assessment (“BPCLA”) environment consistent with certain embodiments of the present disclosure;

FIG. 2A is a block diagram of exemplary business process classification levels consistent with certain embodiments of the present disclosure;

FIG. 2B is a data table of exemplary conformance scores consistent with certain embodiments of the present disclosure;

FIG. 2C is a flow chart of an exemplary BPCLA process consistent with certain embodiments of the present disclosure;

FIG. 2D is a block diagram of an exemplary BPCLA score calculation consistent with certain embodiments of the present disclosure;

FIG. 2E is a flow chart of another exemplary BPCLA process consistent with certain embodiments of the present disclosure;

FIG. 3 is a data table showing an exemplary step in the BPCLA process consistent with certain embodiments of the present disclosure;

FIG. 4 is a data table showing another exemplary step in the BPCLA process consistent with certain embodiments of the present disclosure;

FIG. 5 is a data table showing another exemplary step in the BPCLA process consistent with certain embodiments of the present disclosure;

FIG. 6 is a data table showing another exemplary step in the BPCLA process consistent with certain embodiments of the present disclosure; and

FIG. 7 is a data table showing another exemplary step in the BPCLA process consistent with certain embodiments of the present disclosure.

### DETAILED DESCRIPTION

It is to be understood that both the foregoing general description and the following detailed description are exemplary and explanatory only and are not restrictive of the disclosure as claimed. Reference will now be made in detail to embodiments of the disclosure, examples of which are illustrated in the accompanying drawings. Wherever possible, the same reference numbers will be used throughout the drawings to refer to the same or like parts.

Methods and systems consistent with the disclosed embodiment may include many types of assessment processes or systems for assessing risk and the level of conformance of a business process. The NPI process is used as an example of business processes in the disclosed embodiments. However, it should be noted that applications of the disclosed embodiments are not limited to assessing risk and the level of conformance of any particular type of business process.

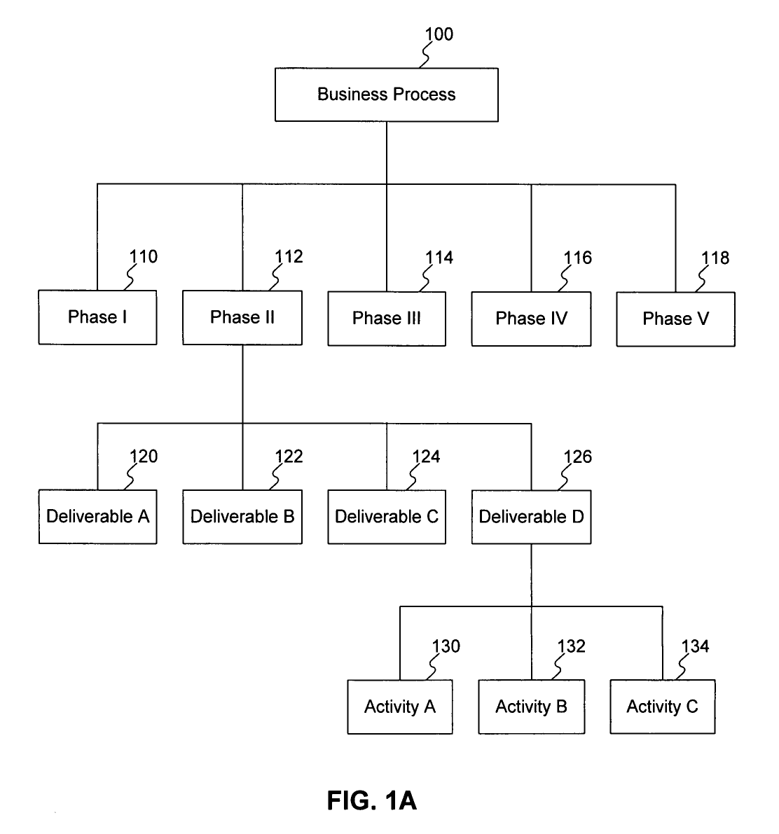

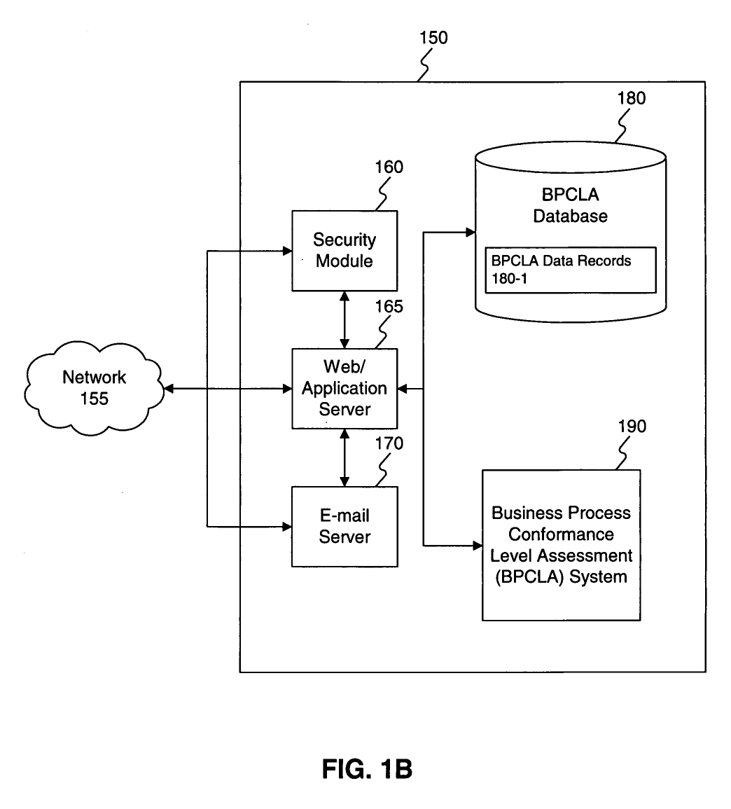

FIG. 1A is a block diagram illustrating an exemplary business process consistent with certain disclosed embodiments. A business process refers to a collection of interrelated tasks, which may solve a particular business issue or achieve a particular business goal. For example, an NPI process is the business process for introducing a new product or a new service to the market.

As shown in FIG. 1A, a business process 100 may include one or more phases, such as a phase I 110, a phase II 112, a phase III 114, a phase IV 116, and a phase V 118. Each phase of business process 100 may have its own attributes and may contribute to achieving the goal of the overall business process. In one embodiment, business process 100 may be an NPI process. A business organization may implement the NPI process to introduce a new product to the market. The NPI process may be implemented by a product team with one or more product managers who are responsible for bringing the new product to market. Similar to the example shown in FIG. 1A, the NPI process may include a strategy phase (i.e., 110), a concept phase (i.e., 112), a development phase (i.e., 114), a pilot phase (i.e., 116), and a production phase (i.e., 118).

Each phase of the NPI process contributes to the overall process. For example, in the strategy phase (110), the product team may register and launch an NPI program for the new product. An NPI program may refer to one specific implementation of the NPI process for introducing a product or a service. In the strategy phase (110), the production team may identify and segment customers and draft the program charter. In the concept phase (112), the NPI program outlined by the product team may be refined and solidified. In the development phase (114), the high-level designs of the new product may be further developed and verified. In the pilot phase (116), the verified product designs may be further validated through pilot testing. The product team may further prepare for the production of the new product. Finally, in the production phase (118), the new product may be produced, delivered to the customer and supported in the marketplace.

Each phase of business process 100 may further be divided into one or more deliverables. Each deliverable may refer to a set of business tasks that may or may not require the product team to produce written documents or other tangible artifacts. The business organization may define business goals for each deliverable. For example, in FIG. 1A, phase I 112 may include four deliverables: a deliverable A 120, a deliverable B 122, a deliverable C 124, and a deliverable D 126. Similarly, other phases of business process 100 may each include one or more deliverables.

In one embodiment, strategy phase 110 of the NPI process may include a “Program & Resource Management” (“PRM”) deliverable. The goal of the PRM deliverable may be for the product team to complete an NPI program plan. The NPI program plan may consist of multiple documents and may include the plans for communication, scope management, resource management, cost management, schedule management, quality management and risk management. The development of the communication, schedule, risk, quality and cost management strategies may be discussed in their respective sections. Because the resources, people, equipment and services involved are typically conditionally available, the product team may also discuss dependencies among the scope, schedule and resource management plans. For example, the NPI program schedule must be designed to accommodate the resource availability. Also, if the scope of the NPI program changes, the schedule and resource needs may be impacted, which could affect the costs. Further, the scope, schedule and resource management plans may provide a means of communication among the product team and other stakeholders.

Strategy phase 110 of the NPI process may also include a “Risk Management” (“RM”) deliverable. The goal of the RM deliverable may be for the product team to identify and plan to mitigate risks in the NPI program. As they complete the activities defined in the RM deliverable, the product team members and other decision-makers may complete a prioritized listing of the identified program risks in order to take appropriate actions in the NPI program. The PRM and RM deliverables may have their own attributes, and both contribute to achieving the goals of strategy phase 110.

Referring back to FIG. 1A, each deliverable of business process 100 may further include one or more activities. An activity may be a part of the business process that may include no further decision making and thus may not need to be further divided (although divisions may be possible). An activity may be a specific task, such as writing a plan to mitigate certain identified risks in the business process.

For example, deliverable D 126 may include an activity A 130, an activity B 132, and an activity C 134. Similarly, other deliverables of business process 100, such as deliverables A-C, may each include one or more activities. In the example of the RM deliverable of the NPI process, the RM deliverable may include a first activity for identifying risks in the NPI process, a second activity for assessing risk probability and impact for each identified risk, and a third activity for generating a risk mitigation plan.

To manage a complex business process, such as the NPI process, a business organization may desire to assess the quality of the implementation of a business process. In one embodiment, a business organization may define a process standard for a business process. To define a process standard, the business organization may collect information from past experiences, research results, as well as input from members of the organization to define a set of best practices or business requirements for each activity included in the business process. For example, the defined best practices may include requirements about how an activity is executed, such as who should participate in the activity, when a product team should start and complete the activity.

In the example of the RM deliverable of the NPI process, the RM deliverable may include a first activity for identifying risks in the NPI process. The business organization may define the process standard for the NPI process. In one embodiment, based on past experience introducing new products to market and research information, the process standard may reflect the requirement that all members of the product team attend a working session to document all potential risks in the NPI process. The business process may further reflect the requirement of conducting the working session no later than two weeks after the NPI implementation is started.

The business organization may further define a conformance score for the business process. The conformance score may indicate how well a specific implementation is conforming to the defined process standard. The business organization may assess the level of conformance of each activity, deliverable, and phase of the business process by determining a conformance score for each activity included in each deliverable and each phase of the process. The business organization may determine the total business process conformance (“BPC”) score based on the conformance scores of one or more activities. FIG. 1B shows an exemplary BPCLA environment which may be used by the business organization to determine the total BPC score for a business process consistent with certain disclosed embodiments.

As shown in FIG. 1B, BPCLA environment 150 may include a security module 160, a web server/application server 165, an email server 170, a BPCLA database 180, and a BPCLA system 190. Web server/application server 165 interfaces with a network 155, security module 160, email server 170, BPCLA database 180, and BPCLA system 190. It is contemplated that BPCLA environment 150 may include some, all, or additional components illustrated in FIG. 1B.

BPCLA environment 150 may be a computer system including hardware/software that enables collaboration among users of BPCLA environment 150, such as one or more product managers. A user of BPCLA environment 150 may be a business manager, such as a product manager or a risk manager of an organization implementing a complex business process, such as the NPI process. A user of BPCLA 100 may generate, maintain, update, delete, and present BPCLA data records and data change entries. A BPCLA data record 180-1 may be any data record related to conformance level assessment and risk assessment processes in BPCLA environment 150.

Network 155 may be any type of wireline or wireless communication network for exchanging or delivering information or signals, such as the Internet, a wireless local area network (LAN), or any other network. Thus, network 155 may be any type of communications system. For example, users and systems of BPCLA environment 150 may send or receive data using network 155.

Security module 160 may be a computer system or software executed by a processor that is configured to determine the type of access to which each user of BPCLA environment 150 is authorized with respect to BPCLA database 180 and/or BPCLA system 190. For example, security module 160 may determine that a first product manager may be authorized to access data records in BPCLA database 180 but may not be authorized to modify the records related to data managed by other users of BPCLA environment 150. A second product manager, on the other hand, may be permitted to access and modify all data records stored in BPCLA database 180. Further, security module 160 may be used to assign and verify different levels of access for different users based on, for example, a user's role in BPCLA environment 150.

Web server/application server 165 may implement any type of web server and/or application server software, such as Apache HTTP Server from the Apache Software Foundation. Web server/application server 165 may include an interface device (e.g., graphical user interface) for a user to access BPCLA database 180, and/or BPCLA system 190. A user of BPCLA environment 150 may enter data and request a conformance level assessment using web server/application server 165.

Further, web server/application server 165 may include additional software/hardware components, such as collaboration tools that permit users of BPCLA environment 150 to share data and information, to work together, bulletin boards to permit users to communicate with each other, and/or search engines to provide efficient access to specific entries in BPCLA database 180 or BPCLA system 190.

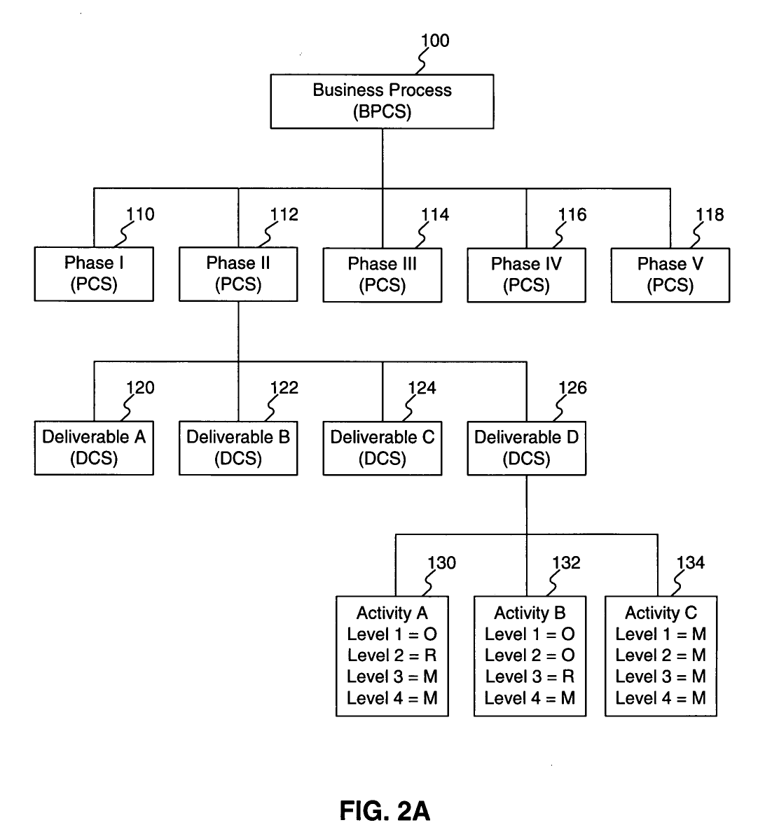

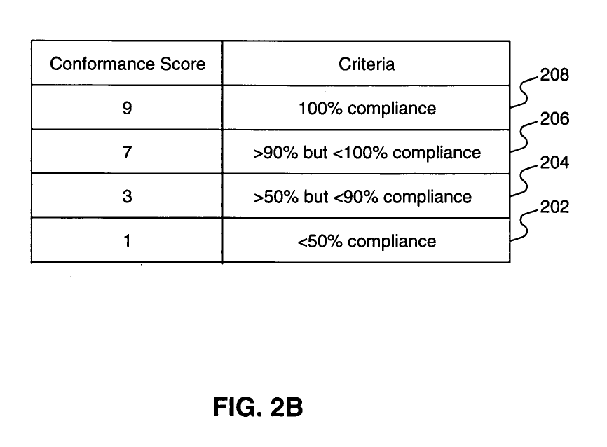

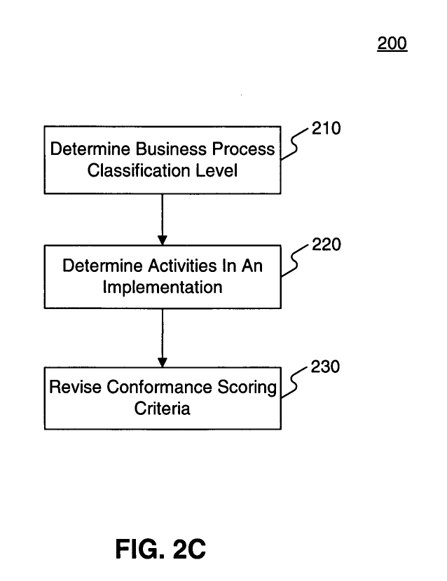

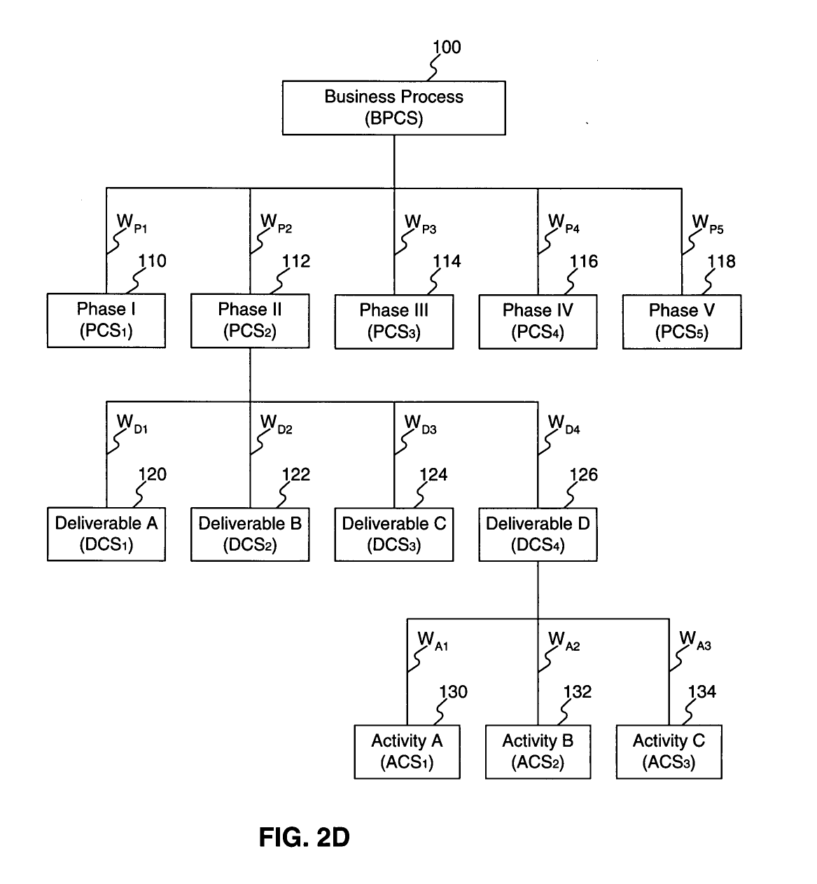

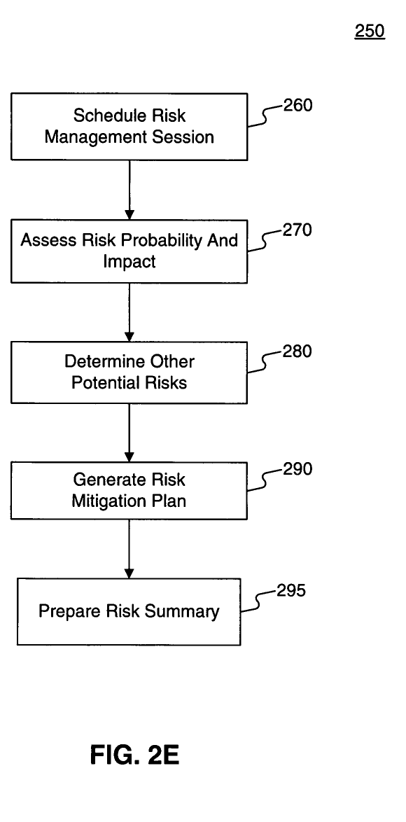

E-mail server 170 may be a computer system or software executed by a processor that is configured to provide e-mail services for users of BPCLA environment 150. The e-mail services may provide messages including current information of BPCLA environment 150. For example, when a conformance score is determined, a product manager may use e-mail server 170 to send messages to other users of BPCLA environment 150. The process for determining a conformance score will be discussed in relation to FIG. 2D below.

BPCLA database 180 may be a system including hardware, firmware, and/or other software executed by a processor that is configured to store data records, charts, entries and changes made to the records, and other information used by users of BPCLA environment 150. For example, BPCLA database 180 may store data records related to one or more NPI processes.

In one embodiment, BPCLA database 180 may store a BPCLA data record 180-1. BPCLA data record 180-1 may include information related to assessing the level of conformance of a business process. BPCLA data record 180-1 may include audit data and/or statistic estimates used to assess the level of conformance of the business process.

In one embodiment, BPCLA data record 180-1 may indicate that the NPI process may include a strategy phase, a concept phase, a development phase, a pilot phase, and a production phase. BPCLA data record 180-1 may also indicate that each phase of the NPI process may include one or more deliverables. For example, each phase of the NPI process may include an RM deliverable. BPCLA data record 180-1 may also indicate that each deliverable of the NPI process may include one or more activities. For example, the RM deliverable for each phase of the NPI process may include an activity that require the product team to identify a list of risks.

Further, BPCLA data record 180-1 may include information related to one or more business process classification levels. In one embodiment, the business organization may define business classification levels for the NPI process based on a product's cost and strategic impact to the business. For example, the business organization may define four classifications levels for the NPI process. FIG. 2A shows exemplary business process classification levels consistent with certain disclosed embodiments.

As shown in FIG. 2A, business process 100, such as the NPI process, may have four classification levels (e.g., see 130, 132, and 134). The business organization may define classification level 4 as the most stringent process to introduce a new product to market. The business organization may require that the product team implement a level 4 NPI program to introduce the most expensive and strategically important products to market. An NPI program refers to a specific implementation of the NPI process (by a product team) for introducing one or more specific products to market. The business organization may define classification levels 3 and 2 as less stringent processes. The business organization may implement a level 3 or a level 2 NPI program to introduce products of moderate level of importance. The business organization may define classification level 1 as the least stringent process. The business organization may implement a level 1 NPI program to introduce a low cost and less important product to market.

In one embodiment, when implementing a level 4 NPI program, the product team may be required to perform all activities in all deliverables and all phases of the NPI process. On the other hand, when implementing a level 3 NPI program, the product team may be allowed to determine whether to perform certain activities in the NPI process, but required to perform other activities in the process.

For example, in FIG. 2A, activity A 130 may be an optional business task for a level 1 NPI program. That is, when the business organization introduces a new product to market using a level 1 NPI program, the product team may determine whether to perform activity A 130 (“0”-optional). When the business organization introduces a second, important, new product to market using a level 2 NPI program, activity A 130 is recommended (“R”) to be conducted by the product team or other decision makers. When the business organization introduce a third, strategically more important, product to market using a level 3 or level 4 NPI program, activity A 130 is mandatory (“M”). Similarly, activity B 132 may be optional for products introduced by a level 1 or a level 2 NPI program. Activity B 132 may be recommended for a product introduced by a level 3 NPI program, and mandatory for products introduced by a level 4 NPI program. Activity C 134 may be mandatory for NPI programs of all classification levels.

Similar to the classification levels for various activities shown in FIG. 2A, the business organization may also define business process classification levels for a deliverable or a phase of a business process (not shown in FIG. 2A). BPCLA data record 180-1 may indicate whether deliverables A, B, C, and D (120, 122, 124, and 126) in phase 11(112) are optional, recommended, or mandatory for NPI programs of different classification levels. BPCLA data record 180-1 may also indicate whether phases I, II, III, IV, and V (110, 112, 114, 116, and 118) are optional, recommended, or mandatory for NPI programs of different classification levels.

In the example of the NPI process, BPCLA record 180-1 may indicate whether the strategy phase of the NPI process is optional, recommended, or mandatory for NPI programs of different classification levels. BPCLA data record 180-1 may also indicate whether the RM deliverable in the strategy phase, is optional, recommended, or mandatory for NPI programs of different classification levels. BPCLA data record 180-1 may also indicate whether an activity in the RM deliverable is optional, recommended, or mandatory for NPI programs of different classification levels.

Referring back to FIG. 1B, BPCLA data record 180-1 may indicate that each activity of the NPI program may correspond to a requirement included in a process standard. As explained earlier, a process standard refers to a set of best practices and business requirements about how (e.g., who should participate, when should a task be completed, etc.) each activity, deliverable, and phase of a business process should be performed.

BPCLA data record 180-1 may also reflect that each activity of the NPI program may have a conformance score. The conformance score may indicate how well the product team performed the activity relative to the defined process standard. For example, the business organization may define a scale of 1-9 to measure the level of conformance. FIG. 2B shows exemplary conformance scores and scoring criteria consistent with certain disclosed embodiments.

In FIG. 2B, a conformance score of 1 may indicate that an activity of the NPI process is performed according to less than 50% of the defined process standard (202). For example, the defined process standard may specify 10 requirements related to how the activity should be performed. The product team may have met only 4 of the 10 requirements.

Similarly, a conformance score of 3 may indicate that that an activity of the NPI process is performed according to more than 50% but less than 90% of the process standard (204). A conformance score of 7 may indicate that an activity of the NPI process is performed according to more than 90% but less than 100% of the process standard (206). A conformance score of 9 may indicate that an activity of the NPI process is performed 100% according to the defined process standard (208). BPCLA data record 180-1 may also indicate that a deliverable or a phase of the NPI process may have a conformance score. The process for determining a conformance score for an activity, deliverable, phase of a business process is discussed further in FIG. 2C below.

Returning to FIG. 1B, BPCLA system 190 may be a computer system or software executed by a processor that is configured to provide access to data records stored in a number of different formats, such as a word processing format, a spreadsheet format, presentation format, and the like. BPCLA system 190 may facilitate capture of BPCLA data records 180-1 and changes to BPCLA data records 180-1, by hosting a management process that facilitates the activities of users of BPCLA environment 150. BPCLA system 190 may also enable users of BPCLA environment 150 to define BPCLA data records 180-1 and the like.

In one embodiment, a business organization may use BPCLA system 190 to implement an NPI program introducing product A to market. The product team may use BPCLA system 190 to initialize the NPI program. The product team may use BPCLA system 190 to define a classification level, to identify activities in the NPI program based on the classification level, and to revise conformance scoring criteria. FIG. 2C shows an exemplary initialization process 200 of the NPI program consistent with certain disclosed embodiments.

As shown in FIG. 2C, the product team may first determine the business classification level of the NPI program. In one embodiment, the product team may define four process classification levels as described earlier in relation to FIG. 2A. Based on the strategic importance of product A, the product team may determine that the NPI program for introducing product A is a level 2 process. The product team may enter this information into BPCLA system 190 (step 210).

As described earlier, each phase, deliverable, or activity of the NPI program may be “optional,” “recommended,” or “mandatory” according to the classification level of the program. After determining that the NPI program is a level 2 process, the product team may then use BPCLA system 190 to determine whether an activity, a deliverable, or a phase is “optional,” “recommended,” or “mandatory” for the program (step 220). The product team may also determine that certain activities are not required for the NPI program. In one embodiment, the product team may mark these activities as “N/A” (not applicable) in BPCLA system 190.

Next, the product team may use BPCLA system 190 to review and revise criteria for conformance scores and other data for activities, deliverables, and phases included in the NPI program (step 230). For example, the product team may adjust the level of conformance required to score a “9” or a “7” as described in FIG. 2B. The product team may enter revisions to the scoring criteria in BPCLA system 190 for the NPI program specifically planned to introduce product A. Further, the product team may also compose or revise questions and associated answers in BPCLA system 190 related to one or more activities, deliverables, and phases of the NPI program.

After completing the initialization process 200, the product team may start the NPI program for introducing product A to market. In each stage of the NPI program, the product team may use BPCLA system 190 to assess the level of conformance of the NPI program based a business process conformance score (“BPCS”). FIG. 2D illustrates an exemplary calculation for a BPCS consistent with certain disclosed embodiments.

As shown in FIG. 2D, in one embodiment, the business organization may use BPCLA system 190 to determine the business process conformance score (“BPCS”) for a business process based on one or more phase conformance scores (“PCS”) corresponding to the phases of the business process. The business organization may also use the BPCLA system 190 to determine the PCS for each phase based on one or more deliverable conformance scores (“DCS”) corresponding to the deliverables in each phase. The business organization may further use the BPCLA system 190 to determine the DCS for each deliverable based on one or more activity conformance scores (“ACS”) for the activities included in each deliverable.

BPCLA system 190 may determine a BPCS for business process 100, such as the NPI process. In one embodiment, the BPCS for business process 100 may be determined based on the PCS for each phase of the process. For example, BPCLA system 190 may determine the BPCS for business process 100 by summing the product of each phase's PCS and the corresponding weight, as shown in equation (1):

$$BPCS = {\sum }_{i} {w}_{pi} \times {PCS}_{i} \qquad ( 1 )$$

wherein PCSᵢ represents the PCS of phase i (i=1, 2, 3, 4, 5) of business process 100; and w_{Pi} represents the weight assigned to PCS of phase i.

In one embodiment, BPCLA system 190 may assign equal weights to the PCS of each phase. For example, in FIG. 2D, five phases are included in business process 100. BPCLA system 190 may thus assign the weight for each phase a value of 0.2 (wₚᵢ=0.2). Alternatively, BPCLA system 190 may assign the weight for each phase based other rules and algorithms.

Similarly, BPCLA system 190 may determine the PCS for each phase as follows:

$${PCS}_{i} = {\sum }_{j} {w}_{Dj} \times {DCS}_{j} \qquad ( 2 )$$

wherein PCSᵢ represents the PCS for phase i (i=1, 2, 3, 4, 5) of business process 100; w_{Dj} represents the weight for each deliverable (j=1, 2, 3, 4) of phase i; and DCSⱼ represents the DCS for each deliverable (j=1, 2, 3, 4) of phase i. BPCLA system 190 may also determine the DCS for each deliverable as follows:

$${DCS}_{j} = {\sum }_{k} {w}_{Ak} \times {ACS}_{k} \qquad ( 3 )$$

wherein DCSⱼ represents the DCS for deliverable j (j=1, 2, 3, 4); w_{Ak} represents the weight for each activity (k=1, 2, 3) of deliverable j; and ACSₖ represents the ACS for each activity k (k=1, 2, 3) of deliverable j.

As shown in FIG. 2D and equations (1)-(3), BPCLA system 190 may determine the conformance score for business process 100 (BPCS) based on the corresponding PCSs, DCSs and ACSs. BPCLA system 190 may determine the conformance score for each phase of the business process (PCS) based on the corresponding DCSs and ACSs. BPCLA system 190 may determine the conformance score for a deliverable (DCS) based on the corresponding ACSs. FIGS. 2E and 3-7 further illustrate the process for determining conformance scores for a set of activities of the NPI program which introduces product A to market.

FIG. 2E shows an exemplary deliverable 250 of the NPI process consistent with certain disclosed embodiments. As explained above, BPCLA system 190 may determine the DCS of deliverable 250 based on the ACSs of the corresponding activities. In one embodiment, deliverable 250 may be the RM deliverable included in one of the phases, such as the strategy phase, of the NPI process. The NPI process may be implemented to introduce product A to market. The specific implementation of the NPI process for product A may be referred to as the NPI program. The NPI program may have four business process classification levels with level 1 reflecting the least stringent and level 4 reflecting the most stringent business process requirements (e.g., see FIG. 2A).

Depending on the classification level of the NPI program, deliverable 250 may be optional, recommended, or mandatory to the product team. Further, as described in relation to FIG. 2C, depending on the classification level of the NPI program, the product team may determine the activities included in deliverable 250 (FIG. 2C, step 220). For example, the product team may determine not to perform a first, optional, activity in deliverable 250. Accordingly, BPCLA system 190 may be configured not to present the first activity to users of BPCLA environment 150 and not to assess the level of conformance of the first activity.

In one embodiment, the business organization may determine that the NPI program for product A is a level 2 process. As shown in FIG. 2E, RM deliverable 250 may include five activities: scheduling a risk management session 260, assessing risk probability and impact 270, determining other potential risks 280, generating risk mitigation plan 290, and preparing risk summary 295. RM deliverable 250 may be a deliverable that provides the product team and other decision makers with a prioritized listing of the identified program risks so that the teams may take appropriate actions needed to ensure program success. Because the risks within the NPI program can vary widely, the entire product team may be required to participate in risk assessment, prioritization and mitigation planning activities 260-295.

Referring to FIG. 2E, the product team may start the process of RM (risk management) deliverable 250 by first scheduling a risk management session (step 260). In one embodiment, a member of the product team may obtain a list of systems and requirements pertinent to new product A. Members of the product team may be required to enter information related to risk factors into BPCLA system 190 prior to the scheduled risk management session. The entire product team as well as other decision makers in the process may be required to attend the risk management session to identify potential risk factors in the NPI program.

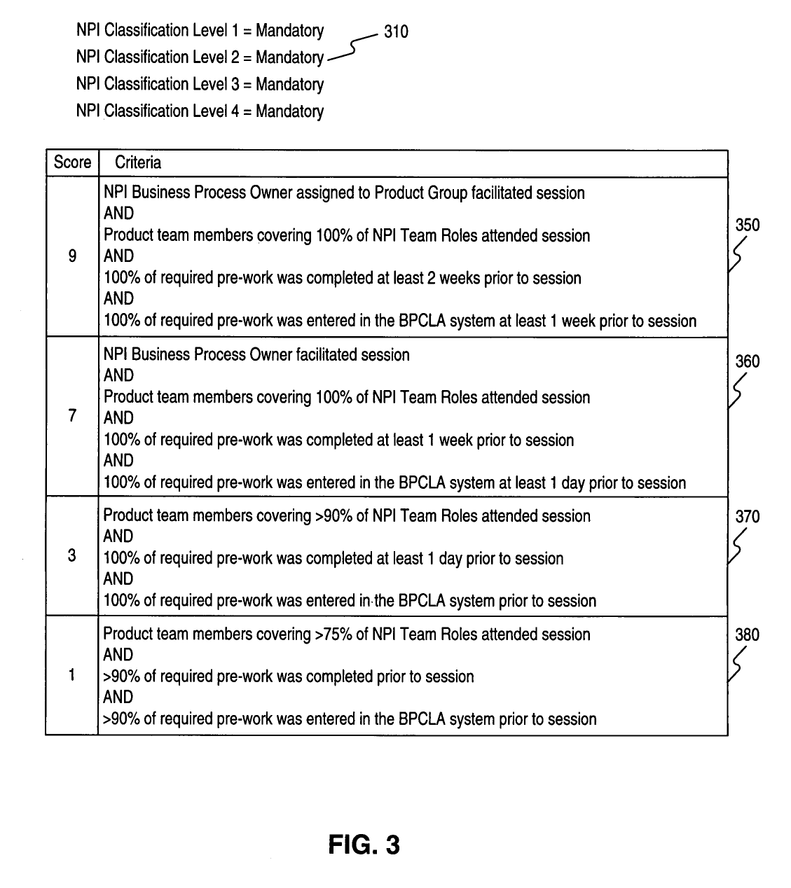

BPCLA system 190 may assess the conformance level of activity 260 based on a conformance score measuring how well the team performed the activity. For example, FIG. 3 shows an exemplary data table used by BPCLA system 190 to determine a conformance score for activity 260 consistent with certain disclosed embodiments.

As shown in FIG. 3, BPCLA system 190 may first determine the process classification level of activity 260. For example, the NPI program for introducing product A to market may be a level 2 process. Activity 260 (i.e., scheduling a risk management session) may thus be a mandatory activity 310.

Next, BPCLA system 190 may determine a conformance score for activity 260 (i.e., ACS). In one embodiment, BPCLA system 190 may present to a user, such as a member of the product team, one or more questions about the team's execution of activity 260. BPCLA system 190 may present multiple choice answers to the questions to the product team member. Each of the answer choices may correspond to a conformance score (i.e., ACS for activity 260).

For example, as shown in FIG. 3, if the product team member selects “NPI business process owner assigned to Product Group facilitated session AND NPI team members covering 100% of NPI Team Roles attended session AND 100% of required pre-work was completed at least 2 weeks prior to session AND 100% of required pre-work was entered in BPCLA system 190 at least 1 week prior to session” (350) as the answer, BPCLA system 190 may assign an ACS of 9 to the product team's execution of activity 260. Alternatively, if a product team member selects another multiple choice answer, such as answers 360, 370, or 380, BPCLA system 190 may assign an ACS of 7, 3, or 1, respectively, to the product team.

Returning to FIG. 2E, after scheduling the risk management session 250, the product team may assess risk probability and impact (step 270). Activity 270 may focus on assessing the probability of risks that are common to all NPI implementations. The questions and associated answers may vary from phase to phase of the NPI program.

In the program initialization process described in FIG. 2C, the product team may compose the questions and associated answers in BPCLA system 190 based on one or more studies that identify common NPI Implementation failure causes (FIG. 2C, step 230). In step 270 (FIG. 2E), if potential risks are identified when answering a question, the product team may capture comments (in a “comments” field in BPCLA system 190) describing “why” the risks exist. The information provided in the “comment” field may be needed to further assess the risks and to create mitigation plan action items.

Activity 270 may also focus on assessing the potential impacts of the identified risks on reliability, program business requirements, program schedule, product cost, etc. These impacts may be common to all NPI implementations. BPCLA system 190 may present a user with a list of questions. The questions and associated multiple choice answers may be the same in each phase. The product team may compose the questions and associated answers in BPCLA system 190 based on one or more studies that determine common NPI risk impacts. If potential risks are identified when answering a question, BPCLA system 190 may capture comments (in the “comments” field in BPCLA system 190) describing “why” the risks exist. The information provided in the “comment” field may be needed to further assess the risks and to create mitigation plan action items.

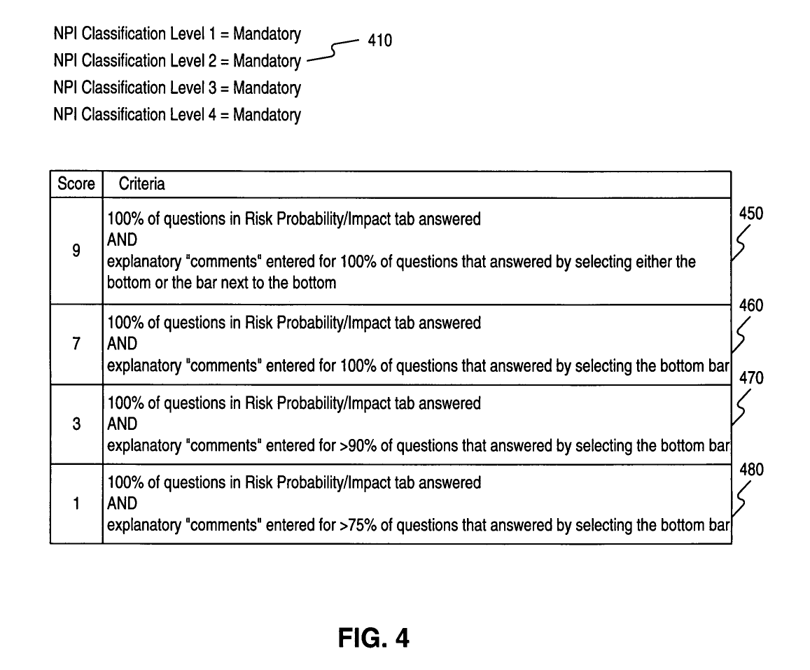

FIG. 4 shows an exemplary data table used by BPCLA system 190 to determine a conformance score for activity 270 consistent with certain disclosed embodiments. As shown in FIG. 4, BPCLA system 190 may first determine the process classification level of activity 270. In the example of product A, the NPI program for introducing product A to market may be a level 2 process. Activity 270 (i.e., assessing risk probability and impact) may be a mandatory activity 410.

Next, BPCLA system 190 may determine a conformance score for activity 270 (i.e., how well has the product team performed activity 270). In one embodiment, BPCLA system 190 may present the product team with a list of questions and analysis to facilitate activity 270. Such questions and analysis may be presented to a user on a Risk Probability/Impact tab of a computer Graphical User Interface (“GUI”). BPCLA system 190 may ask a user, such as a member of the product team, one or more questions about the execution of activity 270.

As shown in FIG. 4, the product team member may select “100% of questions in Risk Probability/Impact tab of BPCLA system 190 answered AND explanatory ‘comments’ entered for 100% of questions that answered by selecting either the bottom or the bar next to the bottom” (450) as the answer, BPCLA system 190 may then assign an ACS of 9 to the product team's execution of activity 270. Alternatively, if a product team member selects another multiple choice answer, such as answers 460, 470, or 480, BPCLA system 190 may assign an ACS of 7, 3, or 1, respectively, to the product team.

Returning to FIG. 2E, next, the product team may determine other potential types of risk (step 280). There may be two types of risk associated with NPI implementations: risks that are common to all NPI programs regardless of the product, and risks that are associated with the product being introduced. Activity 280 may focus on using a brainstorming approach to identify potential risks associated with the specific NPI implementation for the specific product being introduced.

In one embodiment, in performing activity 280, the product team may review various business requirements and systems to identify issues. The product team may conduct a brainstorming session. Instead of answering specific, multiple choice questions, members of the product team may be asked if they have any concerns regarding requirements and systems specific to the NPI program. The product team may also be queried as to whether they have any other concerns not covered by previous questions presented by BPCLA system 190. If additional risks are identified when answering a question, BPCLA system 190 may capture comments (in the “comments” field in BPCLA system 190) providing detailed information related to the risk. This information may be needed to further assess the risks in the NPI program and to create action items to mitigate risk.

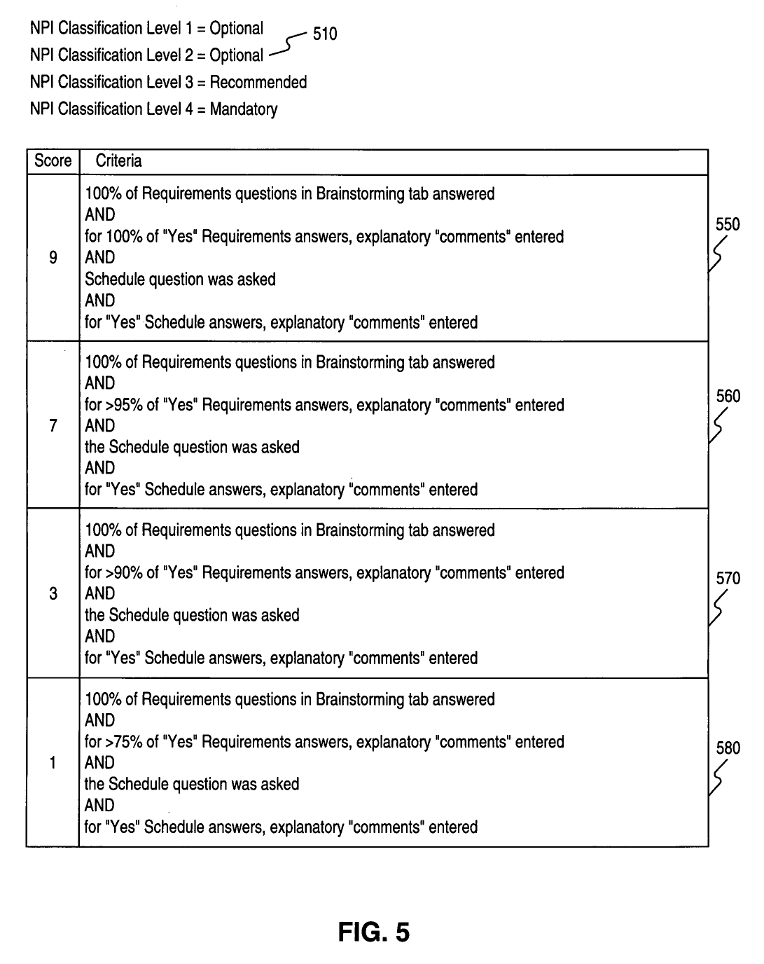

FIG. 5 shows an exemplary data table used by BPCLA system 190 to determine a conformance score for activity 280 consistent with certain disclosed embodiments. As shown in FIG. 5, BPCLA system 190 may first determine the process classification level of activity 280. In the example of product A, the NPI program for introducing product A to market may be a level 2 process. Activity 280 (i.e., determining other potential risks) may be an optional activity 510. That is, the product team may decide whether to perform activity 510 in the NPI program introducing product A to market.

Next, BPCLA system 190 may determine a conformance score for activity 280 (i.e., ACS). In one embodiment, BPCLA system 190 may present the product team with a list of questions and analysis to facilitate activity 280. Such questions and analysis may be presented to a user on a Brainstorming tab through a GUI of BPCLA system 190. BPCLA system 190 may present a user, such as a member of the product team, with one or more questions about the execution of activity 280. In one embodiment, the product team members may identify additional risks by answering “yes” or “no” to questions presented, and further enter comments into BPCLA system 190.

As shown in FIG. 5, the product team member may select “100% of Requirements questions in Brainstorming tab answered AND for 100% of ‘Yes’ Requirements answers, explanatory ‘comments’ entered AND Schedule.question was asked AND for ‘Yes’ Schedule answers, explanatory ‘comments’ entered” (550) as the answer, BPCLA system 190 may then assign an ACS of 9 to the product team's execution of activity 280. Alternatively, if a product team member selects another multiple choice answer, such as answers 560, 570, or 580, BPCLA system 190 may assign an ACS of 7, 3, or 1, respectively, to the product team.

Returning to FIG. 2E, after determining other potential risks, the product team may generate a risk mitigation plan (step 290). In one embodiment, through the previous activities (e.g., 270 and 280) in the RM deliverable, the product team may have identified what risks to include in an NPI program risk mitigation plan. Each risk in the NPI program risk mitigation plan may be assigned to an individual who will be responsible for the execution of the activities required to mitigate the impacts of the risk. These activities may contain specific, quantifiable actions and have target completion dates.

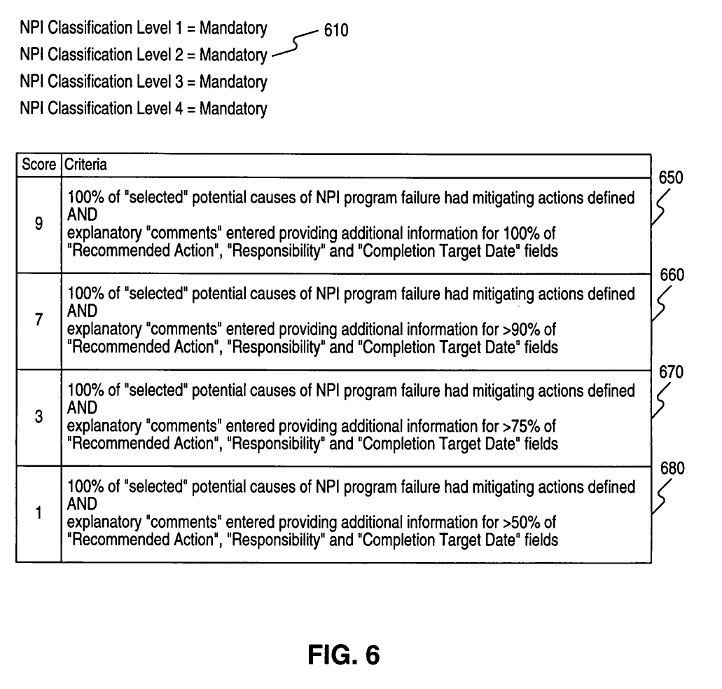

FIG. 6 shows an exemplary data table used by BPCLA system 190 to determine a conformance score for activity 290 consistent with certain disclosed embodiments. As shown in FIG. 6, BPCLA system 190 may first determine the process classification level of activity 290. In the example of product A, the NPI implementation for introducing product A to market may be a level 2 process. Activity 290 (i.e., generating a risk mitigating plan) may be a mandatory activity 610.

Next, BPCLA system 190 may determine a conformance score for activity 290 (i.e., ACS). In one embodiment, BPCLA system 190 may present the product team with a list of questions and analysis to facilitate activity 290. In one embodiment, such questions and analysis may include a list of causes of potential NPI implementation failure and related mitigation actions. BPCLA system 190 may also collect input from the product team about additional information, such as whether a mitigation action is recommended by the product team, the completion date of a specific mitigation action, and the person responsible for managing a mitigation action.

BPCLA system 190 may present to a user, such as a member of the product team, one or more questions about the execution of activity 290. As shown in FIG. 5, the product team member may select “100% of ‘selected’ potential causes of NPI program failure had mitigating actions defined AND explanatory ‘comments’ entered providing additional information for 100% of ‘Recommended Action’, ‘Responsibility’ and ‘Completion Target Date’ fields” (650) as the answer, BPCLA system 190 may then assign an ACS of 9 to the product team's execution of activity 290. Alternatively, if a product team member selects another multiple choice answer, such as answers 660, 670, or 680, BPCLA system 190 may assign an ACS of 7, 3, or 1, respectively, to the product team.

Returning again to FIG. 2E, next, the product team may perform activity 295 to prepare a risk summary (step 295). The product team may evaluate the results of all NPI management activities performed in this phase. A risk management summary may be prepared using one of the templates stored in BPCLA system 190. The risk management summary may be presented in risk reviews with members of the product team and other key decision makers of the NPI program.

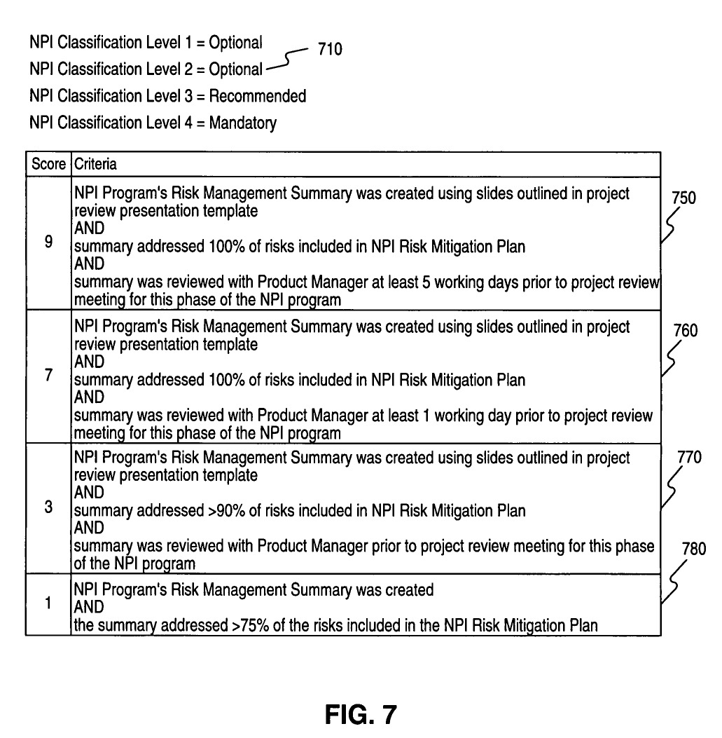

FIG. 7 shows an exemplary data table used by BPCLA system 190 to determine a conformance score for activity 295 consistent with certain disclosed embodiments. As shown in FIG. 7, BPCLA system 190 may first determine the process classification level of activity 295. In the example of product A, the NPI implementation for introducing product A to market may be a level 2 process. Activity 295 (i.e., preparing s risk summary) may be a mandatory activity 710.

Next, BPCLA system 190 may determine a conformance score for activity 295 (i.e., ACS). In one embodiment, BPCLA system 190 may present the product team with a list of questions and analysis to facilitate activity 295. In one embodiment, BPCLA system 190 may provide the product team with a template for an NPI program risk management summary. BPCLA system 190 may also collect input from the product team for additional information, such as whether the risk summary is reviewed by the product manager who is responsible for the production of product A.

BPCLA system 190 may present to a user, such as a member of the product team, with one or more questions about the execution of activity 295. As shown in FIG. 7, the product team member may select “NPI Program's Risk Management Summary was created using slides outlined in the risk review template AND summary addressed 100% of risks included in NPI Risk Mitigation Plan AND summary was reviewed with Product Manager at least 5 working days prior to project review meeting for this phase of the NPI program” (750) as the answer, BPCLA system 190 may then assign an ACS of 9 to the product team's execution of activity 295. Alternatively, if a product team member selects another multiple choice answer, such as answers 760, 770, or 780, BPCLA system 190 may assign an ACS of 7, 3, or 1, respectively, to the product team.

After determining the ACSs for activities 260, 270, 280, 290, and 295, BPCLA system 190 may determine a DCS for RM deliverable 250 using equation (3). In one example, based on the input from the product team, BPCLA system 190 may assign ACSs of 9, 9, 7, 9, and 7 to activities 260, 270, 280, 290, and 295 respectively. BPCLA system 190 may assign equal weights to the ACS for each activity. The DCS for deliverable 250 may therefore be determined as follows:

$$\begin{matrix}{DCS}_{250} = {\sum }_{k} {w}_{Ak} \times {ACS}_{k} \\ = 0.2 \times 9 + 0.2 \times 9 + 0.2 \times 7 + 0.2 \times 9 + 0.2 \times 7 \\ = 8.2\end{matrix}$$

Further, referring back to FIG. 2D, in one embodiment, BPCLA system 190 may adjust the weights w_{Ak} of ACSs based on the business process classification of the NPI program. For example, an optional activity (e.g., activity 280 in FIG. 2E, also see FIG. 5, 510) may be assigned a smaller weight in comparison to a mandatory activity (e.g., activity 270 in FIG. 2E).

BPCLA system 190 may similarly determine the ACSs for activities in other deliverables, and use equation (3) to determine the DCSs for the deliverables. Further, BPCLA system 190 may determine the PCS for each phase of the NPI program using equation (2). For example, the strategy phase of the NPI program for product A may have 10 deliverables. BPCLA system 190 may determine that the 10 deliverables have DCSs of 8, 8.2, 7, 9, 7, 3, 1, 7, 5, and 7. The BPCLA system 190 may also assign equal weights (w=0.1) to the DCSs. The PCS for the strategy phase may therefore be determined as follows:

$$\begin{matrix}{PCS}_{i} = {\sum }_{J} {w}_{Dj} \times {DCS}_{j} \\ = 0.1 \times ( 8 + 8.2 + 7 + 9 + 7 + 3 + 1 + 7 + 5 + 7 ) \\ = 6.22\end{matrix}$$

After determining the PCSs for all phases of the NPI program, BPCLA system 190 may determine the BPCS for the overall process using equation (1). For example, the NPI program for product A may have five phases: the strategy phase, the concept phase, the development phase, the pilot phase, and the production phase. BPCLA system 190 may determine that the five phases have PCSs of 6.22, 7.4, 8.5, 7, and 8. BPCLA system may also assign equal weights to the PCSs. BPCLA system 190 may therefore determine the BPCS for the overall NPI program as follows:

$$\begin{matrix}BPCS = {\sum }_{i} {w}_{pi} \times {PCS}_{i} \\ = 0.2 \times ( 6.22 + 7.4 + 8.5 + 7 + 8 ) \\ = 7.424\end{matrix}$$

Referring back to FIG. 2B, BPCLA system 190 may determine the conformance score for each activity, deliverable, and phase of the NPI program by consistently applying scoring criteria 202, 204, 206, and 208. As such, a BPCS of 7.424 for the overall NPI program for introducing product A to market may indicate that the product team has conformed to more than 90% but less than 100% of the requirements or best practices included in the process standard defined for the NPI process.

### INDUSTRIAL APPLICABILITY

Systems and methods for assessing the level of conformance of a business processes consistent with certain disclosed embodiments may be used to support many types of business processes and functions. In one embodiment, a business organization may use BPCLA system 190 to assess the level of conformance of a complex business process, such as the NPI process. In another embodiment, a business organization may use BPCLA system 190 to assess the level conformance levels of a manufacturing process or a procurement process. The business processes may be divided into one or more phases, with each phase consisting of one or more deliverables. Each deliverable may include one or more activities. The business organization may use BPCLA system 190 to determine the BPCS for each assessed business process. BPCLA system 190 may determine the BPCS based on one or more DCSs and ACSs associated with the assessed business process.

Systems and methods for assessing the conformance level of a business processes consistent with certain disclosed embodiments may be used by many different types of business organizations. For example, both a product manufacturer and a retail distributor may use BPCLA system 190 to assess the level of conformance of various business processes. Systems consistent with certain disclosed embodiments may also be implemented across multiple business organizations to ensure seamless management of a jointly owned business process. For example, an NPI process may be implemented by both a product manufacturer and a product distributor. The product manufacturer may use BPCLA system 190 to assess the level of conformance of a first set of phases, deliverables, and activities of the NPI process. The product distributor may use BPCLA system 190 to assess the conformance level of a second set of phases, deliverables, and activities of the NPI process. To assess the overall level of conformance to a set of defined best practices, the two business organizations may further jointly use BPCLS system 190 to determine a BPCS for the overall NPI implementation across the two organizations.

It will be apparent to those skilled in the art that various modifications and variations can be made in the disclosed embodiments without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A system for assessing a level of conformance of a business process with one or more activities, the system comprising:
a memory to store program code; and
a process to assess the level of conformance, the assessment process comprising:
storing a process standard;
storing a business process classification;
storing a conformance scoring criterion;
determining a first conformance score for a first activity in the business process based on the conformance scoring criterion and the process standard;
determining a second conformance score for a group of activities including the first activity based on one or more conformance scores including the first conformance score;
determining a third conformance score based on the second conformance score; and
assessing the level of conformance of the business process based on the third conformance score.

2. The system of claim 1, wherein the process standard further comprises one or more requirements reflecting how the first activity should be performed in the business process.

3. The system of claim 1, wherein the conformance scoring criterion is associated with the process standard.

4. The system of claims 1, wherein determining the second conformance score further comprises:
assigning a first weight to the first conformance score; and
determining the second conformance score based on the first weight and the first conformance score.

5. The system of claim 4, wherein determining the third conformance score further comprises:
assigning a second weight to the second conformance score; and
determining the third conformance score based on the second weight and the second conformance score.

6. The system of claim 4, wherein assigning the first weight further comprises:
adjusting the first weight based on whether the first activity is mandatory.

7. The system of claim 1, wherein the assessment process further comprises:
presenting the level of conformance of the business process through a user interface.

8. A method for assessing a level of conformance for a business process, comprising:
performing a process for assessing the level of conformance through an interact of a user of a business process conformance level assessment environment, the process comprising:
storing a process standard;
storing a business process classification;
storing a conformance scoring criterion;
determining a first conformance score for a first activity in the business process based on the conformance scoring criterion and the process standard;
determining a second conformance score for a group of activities including the first activity based on one or more conformance scores including the first conformance score;
determining a third conformance score based on the second conformance score; and
assessing the level of conformance of the business process based on the third conformance score.

9. The method of claim 8, wherein the process standard further comprises one or more requirements reflecting how the first activity should be performed in the business process.

10. The method of claim 8, wherein the conformance scoring criteria is associated with the process standard.

11. The method of claims 8, wherein determining the second conformance score further comprises:
assigning a first weight to the first conformance score; and
determining the second conformance score based on the first weight and the first conformance score.

12. The method of claim 11, wherein determining the third conformance score further comprises:
assigning a second weight to the second conformance score; and
determining the third conformance score based on the second weight and the second conformance score.

13. The method of claim 11, wherein assigning the first weight further comprises:
adjusting the first weight based on whether the first activity is mandatory.

14. The method of claim 8, wherein the assessment process further comprises:
presenting the level of conformance of the business process through a user interface.

15. A method for assessing a level of conformance of a business process, comprising:
determining a process standard;
determining a process classification level for the business process;
determining whether one or more activities is required for the business process based on the process classification level;
determining one or more conformance scoring criteria;
determining one or more conformance scores for the one or more required activities based on the one or more conformance scoring criteria; and
assessing the level of conformance based on the one or more conformance scores.

16. The method of claim 16, further comprising:
determining a first conformance score for a first activity in the business process based on the conformance scoring criterion and the process standard;
determining a second conformance score for a group of activities including the first activity based on one or more conformance scores including the first conformance score;
determining a third conformance score based on the second conformance score; and
assessing the level of conformance of the business process based on the third conformance score.

17. The method of claim 16, wherein the process standard further comprises one or more requirements reflecting how the first activity should be performed in the business process.

18. The method of claim 16, wherein the conformance scoring criteria is associated with the process standard.

19. The method of claims 16, wherein determining the second conformance score further comprises:
assigning a first weight to the first conformance score; and
determining the second conformance score based on the first weight and the first conformance score.

20. The method of claim 19, wherein determining the third conformance score further comprises:
assigning a second weight to the second conformance score; and
determining the third conformance score based on the second weight and the second conformance score.
